(19) United States
(12) Patent Application Publication
(10) Pub. No.: US 2025/0102650 A1
(43) Pub. Date: Mar. 27, 2025

(54) VEHICLE SENSOR CALIBRATION METHOD AND SYSTEM

(71) Applicant: ADVANCED INSTITUTE OF CONVERGENCE TECHNOLOGY FOUNDATION INCORPORATED, Suwon-si (KR)

(72) Inventors: Kyung-Il LIM, Seongnam-si (KR); Dong Geun LEE, Incheon (KR)

(21) Appl. No.: 18/970,280

(22) Filed: Dec. 5, 2024

Related U.S. Application Data
(63) Continuation of application No. PCT/KR2024/001911, filed on Feb. 8, 2024.

(30) Foreign Application Priority Data
Mar. 30, 2023 (KR) 10-2023-0041687

(51) Int. Cl. G01S 7/497; G01S 17/42; G01S 17/86; G06T 7/73; G06T 7/80

(52) U.S. Cl. CPC G01S 7/497; G01S 17/42; G01S 17/86; G06T 7/73; G06T 7/80; G06T 2207/30252

(57) ABSTRACT

A vehicle sensor calibration method performed by a vehicle sensor calibration system including one or more infrastructure sensors includes calculating a positional relationship between the infrastructure sensor and a sensor installed in a vehicle by using the infrastructure sensor, calculating a posture of the vehicle and a reference point of the vehicle by using the infrastructure sensor, and generating a coordinate system of the vehicle based on the posture of the vehicle and the reference point of the vehicle, and performing calibration between the vehicle and a sensor installed in the vehicle and including a vehicle camera and a vehicle lidar and using the positional relationship, the posture of the vehicle, the reference point of the vehicle, and the coordinate system.

### CROSS-REFERENCE TO RELATED APPLICATION

This application is a Continuation of International Application No. PCT/KR2024/001911 filed on Feb. 8, 2024, which claims priority to Korean Patent Application No. 10-2023-0041687, filed on Mar. 30, 2023, the entire contents of which are herein incorporated by reference.

### BACKGROUND

### 1. Field

The present disclosure relates to a vehicle sensor calibration system and method, and more particularly, to a vehicle sensor calibration system and method based on the positional relationship between sensors installed in a vehicle such as an autonomous vehicle and sensors installed outside the vehicle and based on center coordinates of the vehicle.

### 2. Description of the Related Art

Recently, research on autonomous driving has been actively conducted. Regarding map data for autonomous driving, local dynamic map 9 LDM) may be classified into four types from Type 1 to Type 4 depending on the dynamic characteristics of information. Here, Type 1 information is “static” information which is map information on roads and buildings, Type 2 information is “quasi-static” information on, for example, landmarks and traffic signs, Type 3 information is “Dynamic” information on which is information on traffic congestion, traffic light information, traffic accident information, construction section information, and road conditions, and Type 4 is “Highly Dynamic” information which is information on surrounding vehicles, pedestrians, and so on.

Although LDM is important in relation to intelligent transportation devices, the LDM is recognized that the LDM has to be able to handle more precise information to be used for autonomous driving.

In addition, autonomous driving requires accurate recognition of the external environment through sensors and so on and determination of driving conditions, such as driving direction and speed based on the recognized information.

Sensors must undergo an initial calibration process while mounted on a vehicle. Calibration is generally performed after a vehicle is moved on a floor surface on which a chessboard pattern is marked, and the vehicle's position and posture have to be properly aligned. A process of moving the vehicle for calibration and aligning a position and posture has a problem in that it is not only time-consuming but also the fields of view between sensors have to overlap each other.

Accordingly, there is a need for research on a separate device for moving a vehicle and a method of calibrating sensors installed on the vehicle without the fields of view between the sensors overlapping each other.

### SUMMARY

The present disclosure provides a method and system for calibrating sensors of a vehicle based on a positional relationship between the sensors installed on the vehicle, such as an autonomous vehicle, and sensors installed outside the vehicle and based on center coordinates of the vehicle.

Technical objects to be achieved by the present disclosure are not limited to the technical objects described above, and other technical objects of the present disclosure may be derived from the following descriptions.

An embodiment according to a first aspect of the present disclosure includes a vehicle sensor calibration method performed by a vehicle sensor calibration system including one or more infrastructure sensors. The vehicle sensor calibration method includes calculating a positional relationship between the infrastructure sensor and a sensor installed in a vehicle by using the infrastructure sensor, calculating a posture of the vehicle and a reference point of the vehicle by using the infrastructure sensor, and generating a coordinate system of the vehicle based on the posture of the vehicle and the reference point of the vehicle, and performing calibration between the vehicle and a sensor installed in the vehicle and including a vehicle camera and a vehicle lidar and using the positional relationship, the posture of the vehicle, the reference point of the vehicle, and the coordinate system.

An embodiment according to a second aspect of the present disclosure includes a vehicle sensor calibration system. The vehicle sensor calibration system includes a communication module configured to transmit and receive information to and from a vehicle, t least one processor, and a memory electrically connected to the at least one processor and storing at least one code executed by the at least one processor, wherein the memory stores a code causing the processor to calculate a positional relationship between the infrastructure sensor and a sensor installed in a vehicle by using the infrastructure sensor, to calculate a posture of the vehicle and a reference point of the vehicle by using the infrastructure sensor, and generating a coordinate system of the vehicle based on the posture of the vehicle and the reference point of the vehicle, and to perform calibration between the vehicle and a sensor installed in the vehicle and including a vehicle camera and a vehicle lidar and using the positional relationship, the posture of the vehicle, the reference point of the vehicle, and the coordinate system.

### BRIEF DESCRIPTION OF THE DRAWINGS

FIG. 1 is a diagram illustrating a vehicle and a vehicle sensor calibration system according to one embodiment of the present disclosure.

FIG. 2 is a diagram illustrating a detailed configuration of the vehicle sensor calibration system illustrated in FIG. 1.

FIG. 3 is a view illustrating an example in which an infrastructure sensor of the vehicle sensor calibration system illustrated in FIG. 1 recognizes a vehicle and a vehicle sensor.

FIG. 4 is a view illustrating an example in which a positional relationship between an infrastructure sensor and a sensor installed in the vehicle is calculated.

FIG. 5 is a view illustrating an example in which a posture of a vehicle is calculated by using an infrastructure sensor.

FIG. 6 is a view illustrating an example in which a coordinate system of a vehicle is calculated and a position of a sensor installed in the vehicle is derived based on the coordinate system.

FIG. 7 is a flowchart illustrating a sequence of a vehicle sensor calibration method according to another embodiment of the present disclosure.

FIGS. 8 and 9 are flowcharts illustrating details of some steps of the vehicle sensor calibration method illustrated in FIG. 7.

### DETAILED DESCRIPTION

Hereafter, the present disclosure will be described in detail with reference to the accompanying drawings. However, the present disclosure may be implemented in many different forms and is not limited to the embodiments described herein. In addition, the accompanying drawings are only for easy understanding of the embodiments disclosed in the present specification, and the technical ideas disclosed in the present specification are not limited by the accompanying drawings. All terms including technical and scientific terms used herein should be interpreted as having the meaning generally understood by a person of ordinary skill in the art to which the present disclosure belongs. Terms defined in advance should be interpreted as having additional meanings consistent with the relevant technical literature and the present disclosure, and unless otherwise defined, should not be interpreted in a very ideal or restrictive sense.

In order to clearly describe the present disclosure in the drawings, parts irrelevant to the descriptions are omitted, and a size, a shape, and a form of each component illustrated in the drawings may be variously modified. The same or similar reference numerals are assigned to the same or similar portions throughout the specification.

Suffixes “module” and “unit” for the components used in the following description are given or used interchangeably in consideration of ease of writing the specification, and do not have meanings or roles that are distinguished from each other by themselves. In addition, in describing the embodiments disclosed in the present disclosure specification, when it is determined that a detailed description of a related known technology may obscure the gist of the embodiments disclosed in the present disclosure, the detailed description is omitted.

Throughout the specification, when a portion is said to be “connected (coupled, in contact with, or combined)” with another portion, this includes not only a case where it is “directly connected (coupled, in contact with, or combined)” “, but also a case where there is another member therebetween. In addition, when a portion “includes (comprises or provides)” a certain component, this does not exclude other components, and means to “include (comprise or provide)” other components unless otherwise described.

Terms indicating ordinal numbers, such as first and second, used in the present specification are used only for the purpose of distinguishing one component from another component and do not limit the order or relationship of the components. For example, the first component of the present disclosure may be referred to as the second component, and similarly, the second element may also be referred to as the first component. As used herein, singular forms should be construed to include plural forms as well, unless the opposite is clearly indicated.

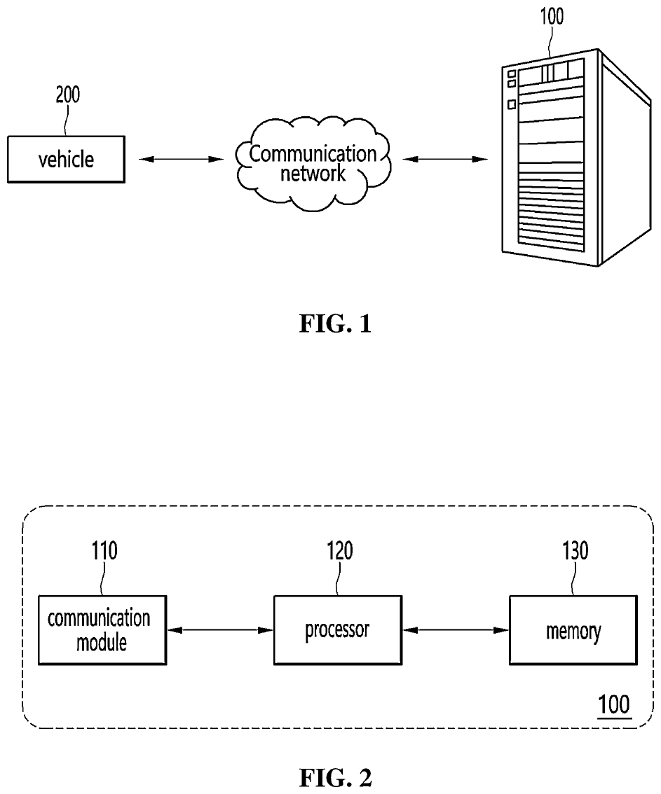

FIG. 1 is a diagram illustrating a vehicle and a vehicle sensor calibration system according to an embodiment of the present disclosure. For the sake of convenience, only one vehicle 200 is illustrated in FIG. 1, but multiple vehicles may be connected to a vehicle sensor calibration system 100 through a wireless network.

The vehicle sensor calibration system 100 includes one or more infrastructure sensors. The infrastructure sensor may include an external camera and an external light detection and ranging (lidar), and may be fixed on the outside of the vehicle 200.

The vehicle sensor calibration system 100 may recognize the vehicle 200 and sensors installed in the vehicle 200 by using the infrastructure sensors.

The vehicle sensor calibration system 100 calculates a positional relationship between the infrastructure sensors and the sensors installed in the vehicle 200 by using the infrastructure sensors. Here, the sensors installed in the vehicle 200 may be a vehicle camera and a vehicle lidar.

The vehicle sensor calibration system 100 calculates a posture of the vehicle 200 and a reference point of the vehicle 200 by using the infrastructure sensor. The vehicle sensor calibration system 100 generates a coordinate system of the vehicle 200 based on the posture of the vehicle 200 and the reference point of the vehicle 200.

The vehicle sensor calibration system 100 may calibrate a sensor installed in the vehicle 200 by using a positional relationship between an infrastructure sensor and a sensor installed in the vehicle 200 calculated by using the infrastructure sensor, a posture of the vehicle 200, a reference point of the vehicle 200, and a coordinate system. For example, the vehicle sensor calibration system 100 may calibrate a vehicle camera and a vehicle lidar by using the positional relationship, a posture of the vehicle 200, a reference point of the vehicle 200, and a coordinate system. Here, the calibration may mean modifying values of sensors currently installed in the vehicle 200 which include initial installation directions, shooting angles, and so on of the sensors. For example, the calibration may include an operation of matching a direction of a camera or lidar installed in the vehicle 200 to a front direction of a vehicle when the direction of the camera or lidar is different from the front direction of the vehicle 200.

The vehicle 200 may be communicably connected to the vehicle sensor calibration system 100. For example, the vehicle 200 may be any vehicle including a general driving vehicle and an autonomous driving vehicle.

Sensors may be installed in the vehicle 200. The sensors installed in the vehicle 200 may be fixed on the outside or inside of the vehicle 200.

The sensors installed in the vehicle 200 may be at least one vehicle camera and at least one vehicle lidar. For example, the vehicle 200 may include one vehicle camera and two vehicle lidars, and in another example, the vehicle 200 may include two vehicle cameras and one vehicle lidar.

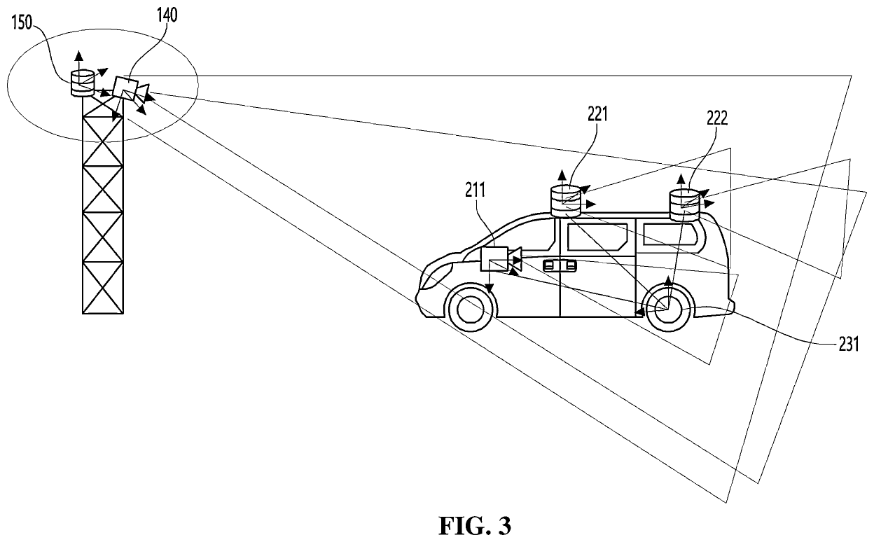

FIG. 2 is a diagram illustrating a detailed configuration of the vehicle sensor calibration system 100 illustrated in FIG. 1.

Referring to FIG. 2, the vehicle sensor calibration system 100 may include a communication module 110, a processor 120, and a memory 130.

The communication module 110 may transmit and receive data to and from the vehicle 200. For example, the communication module 110 may transmit a signal to the vehicle 200 to calibrate sensors installed in the vehicle. The communication module 110 may receive information including positional information of sensors installed in the vehicle 200 from the vehicle 200.

The communication module 110 may include hardware and software necessary for transmitting and receiving signals such as a control signal and data signal through wired or wireless connections with other network devices.

The processor 120 may include various types of devices that control and process data. The processor 120 may refer to a data processing device that is built in hardware and includes a physically structured circuit to perform a function represented by a code or command included in a program.

In one example, the processor 120 may be implemented in the form of a microprocessor, a central processing unit (CPU), a processor core, a multiprocessor, an application-specific integrated circuit (ASIC), a field programmable gate array (FPGA), or so on, but the scope of the present disclosure is not limited thereto.

The processor 120 of the vehicle sensor calibration system 100 performs an operation according to a code stored in a memory 130.

The memory 130 of the vehicle sensor calibration system 100 is electrically connected to the processor 120 and stores at least one code executed by the processor 120. The memory 130 stores a code that causes the processor 120 to perform the following functions and procedures when executed by the processor 120.

The memory 130 stores a code that causes a positional relationship between an infrastructure sensor and a sensor installed in the vehicle 200 to be calculated by using the infrastructure sensor. Here, the positional relationship may include a camera positional relationship between the infrastructure sensor and a vehicle camera, and a lidar positional relationship between the infrastructure sensor and a vehicle lidar.

The memory 130 may store a code that causes a positional relationship between the infrastructure sensor and the vehicle camera to the infrastructure sensor to be calculated by using a camera position estimation algorithm that extracts feature points from an image and matches similar points to each other. For example, the memory 130 may store a code that causes the extraction of feature points of an image based on at least one of a scale-invariant feature transform (SIFT) technique, a speeded up robust features (SURF) technique, and an oriented and rotated brief (ORB) technique and causes the calculation of a positional relationship between an infrastructure sensor and a vehicle camera based on 2 dimensional (D)-2D Epipolar Geometry.

The memory 130 may store a code that causes the calculation of a positional relationship between the infrastructure sensor and a vehicle lidar based on a scan matching algorithm that matches two different point clouds to each other. For example, the memory 130 may store a code that causes the calculation of a positional relationship between the infrastructure sensor and the vehicle lidar based on an iterative closest point (ICP)-based the scan matching algorithm.

The memory 130 may store a code that causes the calculation of a posture of a vehicle 200 and a reference point of the vehicle 200 by using the infrastructure sensor. The memory 130 stores a code that causes a coordinate system of the vehicle 200 to be generated based on the posture of the vehicle 200 and the reference point of the vehicle 200.

The memory 130 may store a code that causes the posture of the vehicle to be detected and a region of interest to be designated for extracting rear wheels of the vehicle. For example, the memory 130 may store a code that causes the posture of the vehicle to be detected by using the estimation of a yaw angle value of the vehicle based on at least one of a preset deep learning algorithm and an L-shape fitting technique.

The memory 130 may store a code that causes a center point of a left rear wheel of the vehicle within the region of interest and a center point of a right rear wheel of the vehicle within the region of interest to be detected.

The memory 130 may store a code that causes a center point of a rear axle of the vehicle to be derived based on the center points of the left rear wheel and the right rear wheel.

The memory 130 may store a code that causes a coordinate system to be calculated based on the center point of the rear axle of the vehicle and a posture of the vehicle.

The memory 130 may store a code that causes a sensor installed in the vehicle 200 to be calculated by using a positional relationship, the posture of the vehicle 200, a reference point of the vehicle 200, and the coordinate system. For example, the memory 130 may store a code that causes a vehicle camera and a vehicle lidar to be calculated by using the positional relationship, the posture of the vehicle 200, the reference point of the vehicle 200, and the coordinate system.

The memory 130 may store a code that causes positional information of each of a vehicle camera and a vehicle lidar to be derived according to the coordinate system based on homogeneous coordinate transformation and causes a sensor installed in the vehicle and the vehicle to be calibrated based on the derived positional information.

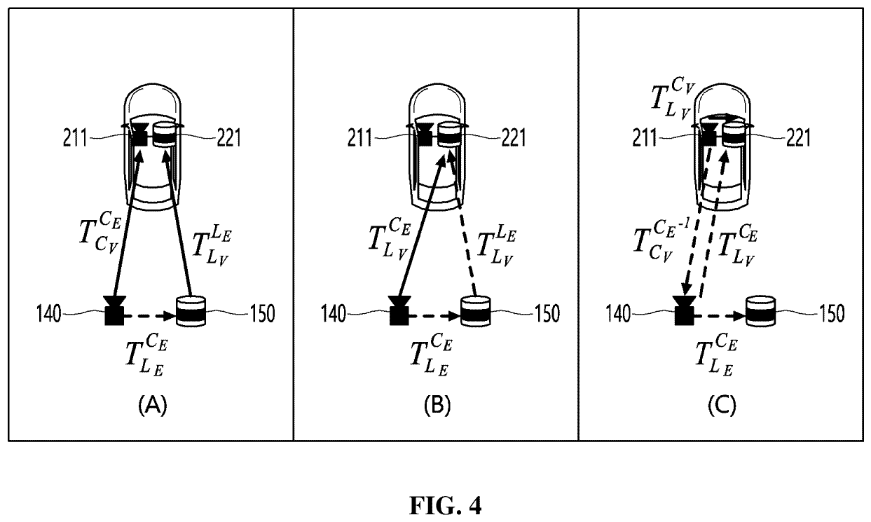

FIG. 3 is a view illustrating an example in which an infrastructure sensor of the vehicle sensor calibration system 100 illustrated in FIG. 1 recognizes a vehicle and a vehicle sensor.

Referring to FIG. 3, the infrastructure sensor may include an external camera 140 and an external lidar 150. The infrastructure sensor may be fixed externally, and an angle of view of the infrastructure sensor installed externally may overlap an angle of view of a sensor installed in a vehicle.

For example, an angle of view of the external camera 140 may overlap an angle of view of each of a vehicle camera 211, a first vehicle lidar 221, and a second vehicle lidar 222. In addition, the angle of view of the external lidar 150 may overlap angles of view of the vehicle camera 211, the first vehicle lidar 221, and the second vehicle lidar 222.

A vehicle sensor calibration system may recognize the entire vehicle by using the infrastructure sensor being installed externally and calculate a posture and reference point of the vehicle. For example, the vehicle sensor calibration system may detect center points of a left rear wheel 231 and a right rear wheel of the vehicle by using the infrastructure sensor.

The vehicle sensor calibration system may derive a center point of a rear axle of the vehicle based on the center points of the left rear wheel 231 and the right rear wheel of the vehicle which are detected by using the infrastructure sensor.

The vehicle sensor calibration system may calculate a vehicle coordinate system based on the derived center point of the rear axle of the vehicle and a posture of the vehicle. For example, the vehicle coordinate system may include information on a direction in which the vehicle's head is directed when the left rear wheel 231 and the right rear wheel of the vehicle are connected in a straight line.

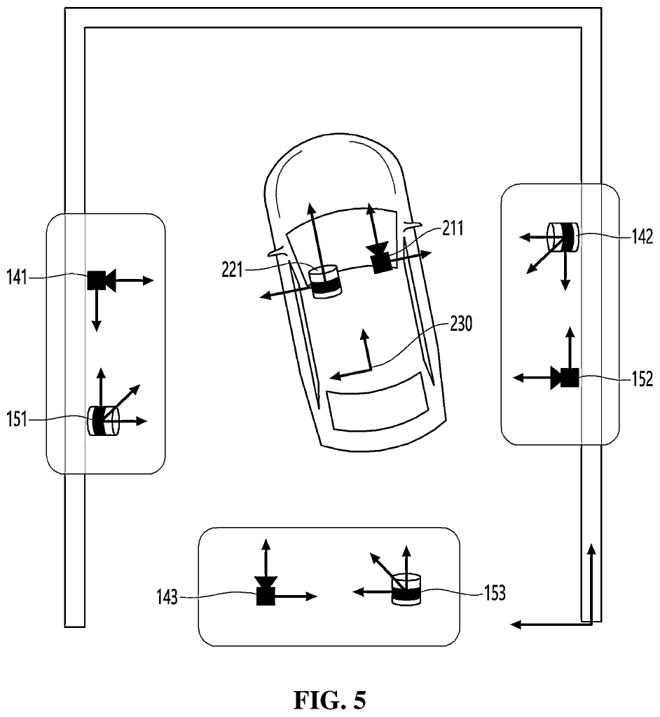

FIG. 4 is a view illustrating an example in which a vehicle sensor calibration system derives a positional relationship between an infrastructure sensor and a sensor installed in a vehicle.

Referring to FIG. 4, the vehicle sensor calibration system may derive a position of a vehicle camera based on an external camera. For example, scale-invariant feature transform (SIFT), oriented fast and rotated brief (ORB), and so on which are mainly used for visual simultaneous localization and mapping (SLAM), may be used.

An external camera may be used as a position reference, and the vehicle sensor calibration system may derive a position of the vehicle camera based on the external camera by using techniques, such as SIFT and ORB, for the external camera image and the vehicle camera image.

The vehicle sensor calibration system may derive a position of the vehicle lidar 221 based on the external lidar 150. For example, the vehicle sensor calibration system may derive the position of the vehicle lidar 221 based on the external lidar 150 using an iterative closest point (ICP)-based alignment method. Here, a reference lidar is an external lidar 150, and a position and posture of the lidar mounted on a vehicle may be derived based on the external lidar 150 by using an ICP-based algorithm.

Referring to (A) of FIG. 4, the vehicle sensor calibration system may calculate a positional relationship between the vehicle camera 211 and the external camera 140, a positional relationship between the vehicle lidar 221 and the external lidar 150, and a positional relationship between the external lidar 150 and the external camera 140. For example, the vehicle sensor calibration system may derive a posture relationship vector T_{CV}^{CE} between the external camera 140 and the vehicle camera 211, a posture relationship vector T_{LV}^{LE} between the external lidar 150 and the vehicle lidar 221, and a posture relationship vector T_{LE}^{CE} between the external camera 140 and the external lidar 150, based on a preset alignment method.

Referring to (B) of FIG. 4, the vehicle sensor calibration system may calculate a positional relationship between the vehicle lidar 221 and the external camera 140, a positional relationship between the external lidar 150 and the external camera 140, and a positional relationship between the vehicle lidar 221 and the external lidar 150. The posture relationship vector T_{LV}^{CE} between the external camera 140 and the vehicle lidar 221, the posture relationship vector T_{LE}^{CE} between the external camera 140 and the external lidar 150, and the posture relationship vector T_{LV}^{LE} between the external lidar 150 and the vehicle lidar 221 may be derived based on the preset alignment method.

Referring to (C) of FIG. 4, the vehicle sensor calibration system may calculate the positional relationship between the vehicle lidar 221 and the external camera 140, the positional relationship between the external camera 140 and the vehicle camera 211, and the positional relationship with the external lidar 150 and the external camera 140. For example, the vehicle sensor calibration system may derive the posture relationship vector T_{LV}^{CE} between the external camera 140 and the vehicle lidar 221, the posture relationship vector T_{CV}^{CE}^{^{−1}} between the external lidar 150 and the vehicle lidar 221, and the posture relationship vector T_{LE}^{CE} between the external camera 140 and the external lidar 150 based on the homogeneous transformation.

The vehicle sensor calibration system may calculate positions of infrastructure sensors installed externally and positions of sensors installed in a vehicle by using the homogeneous transformation and perform calibration between the sensors installed in the vehicle and the vehicle based on the derived positional information of the infrastructure sensors and the sensors installed in the vehicle. For example, as illustrated in (B) of FIG. 4, the posture relationship vector T_{LV}^{CE} between the external camera 140 and the vehicle lidar 221 may be equal to a value obtained by multiplying the posture relationship vector T_{LV}^{LE} between the external lidar 150 and the vehicle lidar 221 by the posture relationship vector T_{LE}^{CE} between the external camera 140 and the external lidar 150.

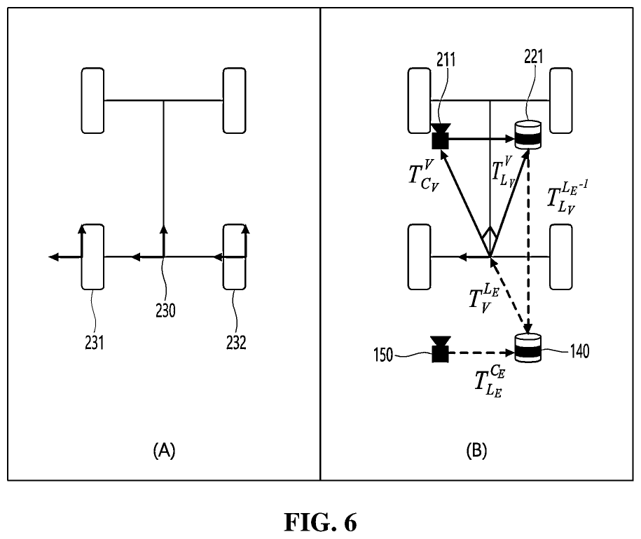

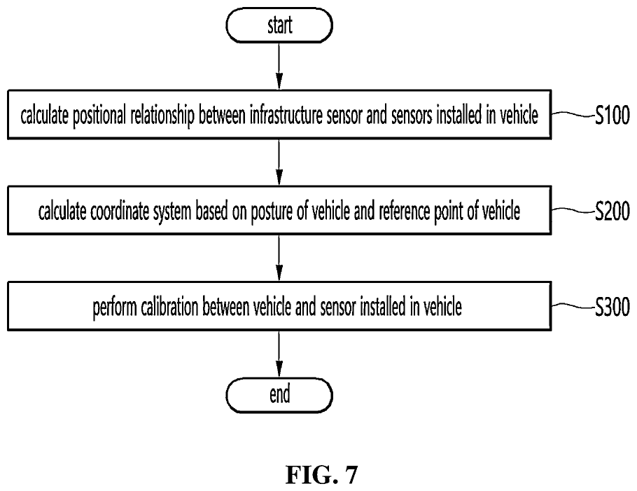

FIG. 5 is a view illustrating an example in which a posture of a vehicle is calculated by using an infrastructure sensor, and FIG. 6 is a view illustrating an example in which a coordinate system of the vehicle is calculated and positions of sensors installed in the vehicle are derived based on the coordinate system.

Referring to FIG. 5 and FIG. 6, the vehicle sensor calibration system may calculate a posture of a vehicle by using one or more infrastructure sensors 141, 142, 143, 151, 152, and 153. For example, the vehicle sensor calibration system may detect the posture of the vehicle by estimating a yaw angle value of the vehicle based on at least one of a preset deep learning algorithm and an L-shape fitting technique.

The vehicle sensor calibration system may designate a region of interest for extracting positions of rear wheels of the vehicle. For example, the vehicle sensor calibration system may designate a region corresponding to a wheel as a region of interest by using external lidars 151, 152, and 153.

The vehicle sensor calibration system may detect a center point of a left rear wheel of the vehicle and a center point of a right rear wheel of the vehicle by using the infrastructure sensors 141, 142, 151, and 152 arranged on the left and right sides of the vehicle to derive a center point of a rear axle of the vehicle.

For example, the vehicle sensor calibration system may detect a position of a left rear wheel 231 and a position of the right rear wheel 232 of the vehicle by using the infrastructure sensors 141, 142, 151, and 152 arranged on the left and right sides of the vehicle, and may detect center points of the left rear wheel and the right rear wheel of the vehicle by using a circle detection technique. However, the present disclosure is not limited thereto, and the vehicle sensor calibration system may detect positions of the left rear wheel 231 and the right rear wheel 232 of the vehicle by using the infrastructure sensors 141, 142, 143, 151, 152, and 153) arranged on the left, right, and rear sides of the vehicle.

The vehicle sensor calibration system may set a median value of the center points of the left rear and the right rear wheel as a reference point of the vehicle.

The vehicle sensor calibration system may derive a coordinate system 230 of the vehicle based on a posture of the vehicle and the reference point of the vehicle. For example, the coordinate system 230 may include information on a direction in which a head of the vehicle is directed from the reference point of the vehicle. Here, the reference point of the vehicle may be the center point of a rear axle of the vehicle.

The vehicle sensor calibration system may calibrate a sensor installed in the vehicle based on a positional relationship between an infrastructure sensor and the sensor installed in the vehicle, the posture of the vehicle, the reference point of the vehicle, and the coordinate system. In this case, the vehicle sensor calibration system may derive positional information of each of a vehicle camera and a vehicle lidar based on the coordinate system by using a homogeneous transformation, and perform calibration between the vehicle camera and the vehicle lidar and the vehicle based on the derived positional information.

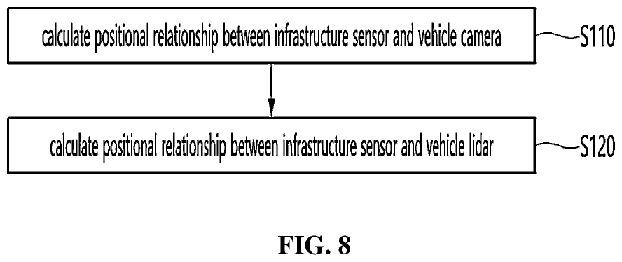

FIG. 7 is a flowchart illustrating a sequence of a vehicle sensor calibration method according to another embodiment of the present disclosure.

The vehicle sensor calibration method to be described below may be performed by the vehicle sensor calibration system 100 of FIG. 1 described above with reference to FIG. 1 to FIG. 6. Therefore, the descriptions of the embodiments of the present disclosure described above with reference to FIGS. 1 to 6 may be equally applied to embodiments described below, and redundant descriptions thereof are omitted below. The steps described below do not necessarily have to be performed sequentially, and the order of the steps may be set in various ways, and the steps may be performed almost simultaneously.

Referring to FIG. 7, the vehicle sensor calibration method includes step S100 of calculating a positional relationship between an infrastructure sensor and a sensor installed in a vehicle, step S200 of calculating a coordinate system based on a posture of the vehicle and a reference point of the vehicle, and step S300 of performing calibration between the sensor installed in the vehicle and the vehicle.

Step S100 of calculating the positional relationship between the infrastructure sensor and the sensor installed in the vehicle is a step of calculating the positional relationship between the infrastructure sensor and the sensors installed in the vehicle by using the infrastructure sensor. Here, the positional relationship may include a camera positional relationship between the infrastructure sensor and a vehicle camera, and a lidar positional relationship between the infrastructure sensor and a vehicle lidar.

Step S200 of calculating the coordinate system based on the posture of the vehicle and the reference point of the vehicle is a step of calculating the posture of the vehicle and the reference point of the vehicle by using the infrastructure sensor, and generating the coordinate system of the vehicle based on the posture of the vehicle and the reference point of the vehicle.

Step S300 of calibrating the sensor installed in the vehicle is a step of calibrating the sensor which is installed in the vehicle and includes the vehicle camera and the vehicle lidar, by using the positional relationship between the infrastructure sensor and the sensor installed in the vehicle 200, the posture of the vehicle, the reference point of the vehicle, and the coordinate system calculated by using the infrastructure sensor. For example, in step S300 of calibrating the sensor installed in the vehicle, calibration between the vehicle and the vehicle camera and the vehicle lidar may be performed by using the positional relationship, the posture of the vehicle, the reference point of the vehicle, and the coordinate system. That is, in step S300 of calibrating the sensor installed in the vehicle, calibration between the vehicle and the vehicle camera and calibration between the vehicle and the vehicle lidar may be performed.

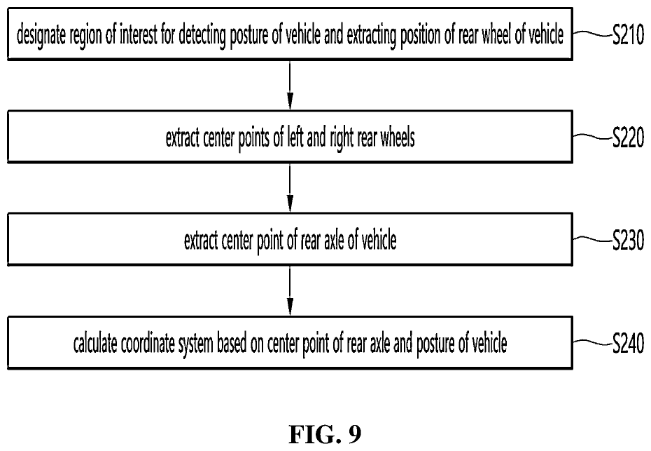

FIGS. 8 and 9 are flowcharts illustrating details of some steps of the vehicle sensor calibration method illustrated in FIG. 7.

Referring to FIG. 8, step S100 of calculating the positional relationship between the infrastructure sensor and the sensor installed on the vehicle may include step S110 of calculating a positional relationship between the infrastructure sensor and a vehicle camera, and step S120 of calculating a positional relationship between the infrastructure sensor and a vehicle lidar.

Step S110 of calculating the positional relationship between the infrastructure sensor and the vehicle camera may be a step of calculating the positional relationship between the infrastructure sensor and the vehicle camera based on at least one of a SIFT technique, a SURF technique, and an ORB technique.

Step S120 of calculating the positional relationship between the infrastructure sensor and the vehicle lidar may be a step of calculating the positional relationship between the infrastructure sensor and the vehicle lidar based on an ICP-based scan matching algorithm.

Referring to FIG. 9, step S200 of calculating a coordinate system based on a vehicle posture and a vehicle reference point may include step S210 of designating a region of interest for detecting a posture of a vehicle and extracting a position of a rear wheel of the vehicle, step S220 of extracting center points of left and right rear wheels, step S230 of extracting a center point of a rear axle of the vehicle, and step S240 of calculating a coordinate system based on the center point of the rear axle and posture of the vehicle.

Step S210 of designating the region of interest for detecting the vehicle posture and extracting the position of the rear wheel of the vehicle may be a step of detecting a posture of the vehicle and designating a region of interest for extracting the rear wheel of the vehicle. For example, in step S210 of designating the region of interest for detecting the posture of the vehicle and extracting the position of the rear wheel of the vehicle, a region corresponding to a wheel may be designated as the region of interest by using an external lidar.

Step S220 of extracting the center points of the left and right rear wheels may be a step of detecting the center points of the left and right rear wheels of the vehicle within the region of interest. In step S220 of extracting the center points of the left rear wheel and right rear wheel, the center points of the left rear wheel and right rear wheel of the vehicle may be detected by using infrastructure sensors arranged on the left and right sides of the vehicle to derive a center point of a rear axle of the vehicle.

Step S230 of extracting the center point of the rear axle of the vehicle may be a step of deriving the center point of the rear axle of the vehicle based on the center points of the left rear wheel and the right rear wheel. In step S230 of extracting the center point of the rear axle of the vehicle, a median value of the center point of the left rear wheel and the center point of the right rear wheel as the center point of the rear axle of the vehicle.

Step S240 of calculating the coordinate system based on the center point of the rear axle and the posture of the vehicle may be a step of calculating the coordinate system based on the center point of the rear axle of the vehicle and the posture of the vehicle. Here, the coordinate system may include information on a direction in which a head of the vehicle is directed from the reference point of the vehicle.

According to the present disclosure, automated vehicle sensor calibration may be performed by using infrastructure sensors located outside a vehicle without procedures such as attaching a separate device to the vehicle or moving the vehicle to a specific space to calibrate the vehicle sensors, compared to the conventional technology, and thus, spatial gains may be increased.

In addition, according to the present disclosure, vehicle sensor calibration may be performed by using relatively inexpensive cameras and lidars without additionally using expensive equipment, and thus, cost efficiency may be increased.

In addition, according to the present disclosure, sensor calibration may be performed even when the fields of view between sensors inside the vehicle do not overlap each other.

Effects of the present disclosure are not limited to the effects described above and include all effects understood from the above description.

A person having ordinary skill in the art to which the present disclosure pertains will understand that the present disclosure may be easily modified into other specific forms without changing the technical idea or essential features of the present disclosure based on the above description. Therefore, the embodiments described above should be understood as illustrative in all respects and not limiting. The scope of the present application is indicated by the claims described below rather than the detailed description above, and all changes or modified forms derived from the meaning, scope of the claims, and their equivalent concepts should be interpreted as being included in the scope of the present application. The scope of the present application is indicated by the claims described below rather than the detailed description above, and all changes or modified forms derived from the meaning, scope of the claims, and their equivalent concepts should be interpreted as being included in the scope of the present application.

### Industrial Applicability

The present disclosure is based on the positional relationship between sensors equipped in a vehicle and sensors installed outside the vehicle and the center coordinates of the vehicle. It has industrial applicability as it may be used in technology to calibrate vehicle sensors.

What is claimed is:

1. A vehicle sensor calibration method performed by a vehicle sensor calibration system including one or more infrastructure sensors, the vehicle sensor calibration method comprising:
calculating a positional relationship between the infrastructure sensor and a sensor installed in a vehicle by using the infrastructure sensor;
calculating a posture of the vehicle and a reference point of the vehicle by using the infrastructure sensor, and generating a coordinate system of the vehicle based on the posture of the vehicle and the reference point of the vehicle; and
performing calibration between the vehicle and a sensor installed in the vehicle and including a vehicle camera and a vehicle lidar and using the positional relationship, the posture of the vehicle, the reference point of the vehicle, and the coordinate system.

2. The vehicle sensor calibration method of claim 1, wherein
the positional relationship includes a camera positional relationship between the infrastructure sensor and the vehicle camera, and a lidar positional relationship between the infrastructure sensor and the vehicle lidar.

3. The vehicle sensor calibration method of claim 1, wherein
the infrastructure sensor includes an external camera and an external lidar and is fixed outside the vehicle.

4. The vehicle sensor calibration method of claim 1, wherein the calculating of the positional relationship comprises:
calculating the positional relationship between the infrastructure sensor and the vehicle camera based on at least one of a scale-invariant feature transform (SIFT) technique, a speeded up robust features (SURF) technique, and an oriented and rotated brief (ORB) technique; and
calculating a positional relationship between the infrastructure sensor and the vehicle lidar based on an iterative closest point (ICP)-based scan matching algorithm.

5. The vehicle sensor calibration method of claim 1, wherein the calculating the posture of the vehicle and the reference point of the vehicle comprises:
detecting the posture of the vehicle and designating a region of interest for extracting a position of a rear wheel of the vehicle;
detecting a center point of a left rear wheel of the vehicle and a center point of a right rear wheel of the vehicle within the region of interest;
deriving a center point of a rear axle of the vehicle based on the center point of the left rear wheel and the center point of the right rear wheel; and
calculating the coordinate system based on the center point of the rear axle of the vehicle and the posture of the vehicle.

6. The vehicle sensor calibration method of claim 5, wherein
the posture of the vehicle is detected by estimating a yaw angle value of the vehicle based on at least one of a preset deep learning algorithm and an L-shape fitting technique.

7. The vehicle sensor calibration method of claim 1, wherein
the performing of the calibration further comprises deriving positional information of each of the vehicle camera and the vehicle lidar according to the coordinate system based on a homogeneous coordinate transformation, and performing calibration between the sensor installed in the vehicle and the vehicle based on the derived positional information.

8. A vehicle sensor calibration system including one or more infrastructure sensors, the vehicle sensor calibration system comprising:
a communication module configured to transmit and receive information to and from a vehicle;
at least one processor; and
a memory electrically connected to the at least one processor and storing at least one code executed by the at least one processor,
wherein the memory stores a code causing the processor to calculate a positional relationship between the infrastructure sensor and a sensor installed in a vehicle by using the infrastructure sensor, to calculate a posture of the vehicle and a reference point of the vehicle by using the infrastructure sensor, and generating a coordinate system of the vehicle based on the posture of the vehicle and the reference point of the vehicle, and to perform calibration between the vehicle and a sensor installed in the vehicle and including a vehicle camera and a vehicle lidar and using the positional relationship, the posture of the vehicle, the reference point of the vehicle, and the coordinate system.

9. The vehicle sensor calibration system of claim 8, wherein
the positional relationship includes a camera positional relationship between the infrastructure sensor and the vehicle camera, and a lidar positional relationship between the infrastructure sensor and the vehicle lidar.

10. The vehicle sensor calibration system of claim 8, wherein
the infrastructure sensor includes an external camera and an external lidar and is fixed outside the vehicle.

11. The vehicle sensor calibration system of claim 8, wherein
the memory stores a code causing the processor to calculate the positional relationship between the infrastructure sensor and the vehicle camera based on at least one of a scale-invariant feature transform (SIFT) technique, a speeded up robust features (SURF) technique, and an oriented and rotated brief (ORB) technique, and to calculate a positional relationship between the infrastructure sensor and the vehicle lidar based on an iterative closest point (ICP)-based scan matching algorithm.

12. The vehicle sensor calibration system of claim 8, wherein
the memory stores a code causing the processor to detect the posture of the vehicle and designating a region of interest for extracting a position of a rear wheel of the vehicle, detect a center point of a left rear wheel of the vehicle and a center point of a right rear wheel of the vehicle within the region of interest, derive a center point of a rear axle of the vehicle based on the center point of the left rear wheel and the center point of the right rear wheel, and calculate the coordinate system based on the center point of the rear axle of the vehicle and the posture of the vehicle.

13. The vehicle sensor calibration system of claim 12, wherein
the memory stores a code causing the processor to detect the posture of the vehicle by estimating a yaw angle value of the vehicle based on at least one of a preset deep learning algorithm and an L-shape fitting technique.

14. The vehicle sensor calibration system of claim 8, wherein
the memory stores a code causing the processor to derive positional information of each of the vehicle camera and the vehicle lidar according to the coordinate system based on a homogeneous coordinate transformation, and performing calibration between the sensor installed in the vehicle and the vehicle based on the derived positional information.
